(19) United States
(12) Patent Application Publication
(10) Pub. No.: US 2025/0206129 A1
(43) Pub. Date: Jun. 26, 2025

(54) GRILLE SHUTTER DEVICE

(71) Applicant: TOYOTA JIDOSHA KABUSHIKI KAISHA, Toyota-shi (JP)

(72) Inventor: Eiji ISHIKAWA, Okazaki-shi (JP)

(21) Appl. No.: 18/945,548

(22) Filed: Nov. 13, 2024

(30) Foreign Application Priority Data
Dec. 25, 2023 (JP) 2023-218572

(51) Int. Cl. B60K 11/08

(52) U.S. Cl. CPC B60K 11/085

(57) ABSTRACT

A grille shutter device, including: a rotary member having one end part that is supported by a rotary shaft along a vehicle width direction at an upper part or a lower part, in a vehicle vertical direction, of a grille opening of a vehicle, the rotary member being rotatable around the rotary shaft; a single opening and closing member fixed to another end part of the rotary member, which assumes a horizontal orientation and puts the grille opening into an open state when the rotary member is upright, and which assumes an inclined orientation or an upright orientation and puts the grille opening into a closed state when the rotary member is inclined; and a support member having one end part rotatably supported at the vehicle, and another end part that moves relative to the opening and closing member in conjunction with the grille opening.

### CROSS-REFERENCE TO RELATED APPLICATION

This application is based on and claims priority under 35 USC 119 from Japanese Patent Application No. 2023-218572, filed on Dec. 25, 2023, the entire disclosure of which is incorporated by reference herein.

### BACKGROUND

### Technical Field

The present disclosure relates to a grille shutter device installed in a vehicle.

### Related Art

Japanese Patent Application Laid-open (JP-A) No. 2016-210244 discloses a grille shutter in which, with respect to a front grille including plural clearance openings arrayed in a vehicle vertical direction, respective clearance openings are closed from the rear side of the front grille by rotatable movement of each of plural closure plates.

In recent years, there has been a trend toward front grilles having a common design shape for each brand, and there is also a trend toward reflecting the design in the grille opening of the front grille, and therefore, there is room for improvement in the shape of a shutter provided at a grille opening. In the grille shutter described in JP-A No. 2016-210244, a closure plate is provided for each of plural clearance openings arrayed in the vehicle vertical direction. Therefore, even in a case in which closure plates are in an open state, it is difficult to secure a larger opening in the vehicle vertical direction owing to the closure plates being positioned in the grille opening height direction. Since a closure plate is provided for each clearance opening, it is not easy to make the shapes of the respective closure plates correspond to the clearance openings when the shapes of the clearance openings are made different in order to improve design properties.

### SUMMARY

The present disclosure provides a grille shutter device that is capable of improving design performance while enabling a larger opening area to be secured with a simpler structure.

A grille shutter device according to a first aspect includes: a rotary member having one end part that is supported by a rotary shaft along a vehicle width direction at an upper part or a lower part, in a vehicle vertical direction, of a grille opening of a vehicle, the rotary member being rotatable around the rotary shaft; a single opening and closing member fixed to another end part of the rotary member, which assumes a horizontal orientation and puts the grille opening into an open state when the rotary member is upright, and which assumes an inclined orientation or an upright orientation and puts the grille opening into a closed state when the rotary member is inclined; and a support member having one end part rotatably supported at the vehicle around an axis along the vehicle width direction, and another end part that moves relative to the opening and closing member in conjunction with an opening and closing operation of the grille opening.

In the grille shutter device according to the first aspect, when the grille opening is in the closed state, the face of the opening and closing member at the side of the grille opening faces the grille opening, and therefore, the face at the grille opening side can configure a design face. In addition, since the grille opening can be opened and closed by a single opening and closing member, without requiring plural opening and closing members, it is possible to accommodate front grilles of various shapes with improved design properties. Since the opening and closing member is in a horizontal orientation when the grille opening is in an open state, a larger opening area can be secured in the vehicle vertical direction. Since one end portion of the support member is rotatably supported at the vehicle, and the other end portion of the support member moves relative to the opening and closing member in accordance with an opening and closing operation of the grille opening, the grille opening can be opened and closed by a uniaxial rotation drive mechanism at one end portion of the rotary member. Thus, in the grille shutter device according to the present disclosure as set forth in claim 1, designability can be improved at the same time that a larger opening area is secured with a simpler structure.

A grille shutter device according to a second aspect has the configuration of the first aspect, in which, when the grille opening is in a closed state, the opening and closing member and the support member are disposed in a substantial L-shape having an apex at a vehicle rear side, as viewed from the vehicle width direction.

In the grille shutter device according to the second aspect, since, when the grille opening is in the closed state, the opening and closing member and the support member are disposed in a substantial L-shape having an apex at a vehicle rear side, as viewed from the vehicle width direction, the grille shutter device can be made, for example, to correspond to a so-called spindle-shaped front grille that is longitudinally long and that is shaped so as to be constricted toward the vehicle width direction inner side at a position above the center in the vehicle vertical direction.

A grille shutter device according to a third aspect has the configuration of the first aspect or the second aspect, in which the opening and closing member is provided with an opening portion that is open in an elongated shape at respective end faces in the vehicle width direction, and the support member is provided, at both end faces, with an engagement portion that engages with the opening portion from an outer side in the vehicle width direction, and that slides along the opening portion inside the opening portion.

In the grille shutter device according to the third aspect, the support member is provided with an engagement portion that is engaged with the opening portion of the opening and closing member from the vehicle width direction outer side at both vehicle width direction end sides, and that slides along the opening portion inside the opening portion. Thus, the support member can move relative to the opening and closing member as a result of the engagement portion sliding inside the opening portion.

A grille shutter device according to a fourth aspect has the configuration of any one of the first to third aspects, in which the rotary shaft of the rotary member is provided at a lower side, in the vehicle vertical direction, of the grille opening.

In the grille shutter device according to the fourth aspect, since the rotary shaft of the rotary member is provided at a lower side, in the vehicle vertical direction, of the grille opening, interference with peripheral components such as a wind guide mechanism can be suppressed compared to cases in which it is provided at the upper side.

A grille shutter device according to a fifth aspect has the configuration of any one of the first to fourth aspects, in which the opening and closing member is chamfered such that, when the opening and closing member is in a horizontal orientation, the support member and the opening and closing member are smoothly connected at a side of the grille opening.

In the grille shutter device according to the fifth aspect, since the opening and closing member is chamfered such that the support member and the opening and closing member are smoothly connected at the grille opening side when the opening and closing member is in a horizontal orientation, resistance to air guided through the grille opening can be reduced, enabling air to flow rearward more efficiently.

The grille shutter device according to the present disclosure can improve designability while also ensuring a larger opening area with a simpler structure.

### BRIEF DESCRIPTION OF THE DRAWINGS

Exemplary embodiments of the present disclosure will be described in detail based on the following figures, wherein:

FIG. 1 is a side view schematically illustrating a configuration of a grille shutter device according to an exemplary embodiment of the present disclosure;

FIG. 2 is a perspective view from an oblique front side, schematically illustrating pertinent portions of the grille shutter device of FIG. 1;

FIG. 3 is a top view schematically illustrating a support member; and

FIG. 4 is a side view schematically illustrating pertinent portions of another exemplary embodiment of the grille shutter device of FIG. 1.

### DETAILED DESCRIPTION

Explanation follows regarding a grille shutter device 20 according to an exemplary embodiment of the present disclosure, with reference to the appended drawings. Note that in the present specification and drawings, constituent elements that have substantially the same functional configurations are appended with the same reference numerals, and repeated explanation is omitted. In each of the drawings as appropriate, the arrow UP, the arrow FR, and the arrow W respectively indicate the upper direction, the front direction, and the left and right direction (vehicle width direction) of a vehicle 10 in which the grille shutter device 20 is installed.

Note that in the present exemplary embodiment, the vehicle 10 in which the grille shutter device 20 is installed is any one of a gasoline vehicle, a hybrid electric vehicle (HEV), a plug-in hybrid electric vehicle (PHEV), a fuel cell electric vehicle (FCEV), an electric vehicle (BEV), or the like, for example.

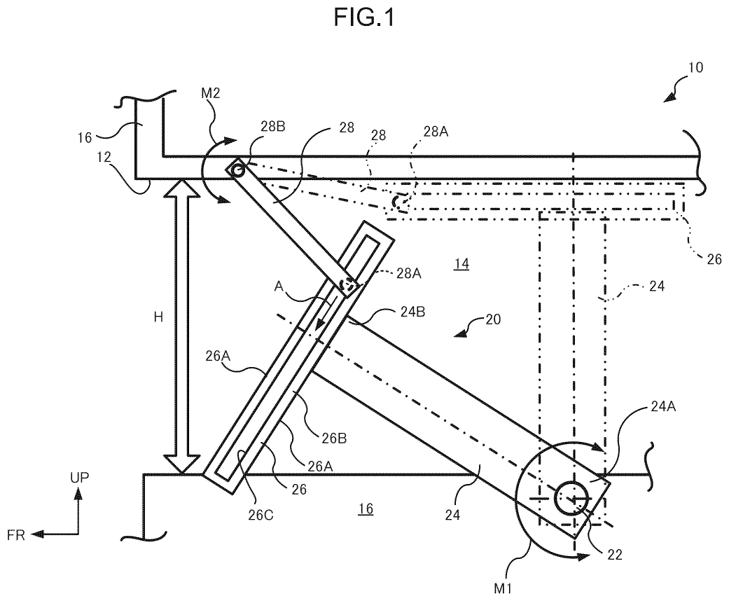

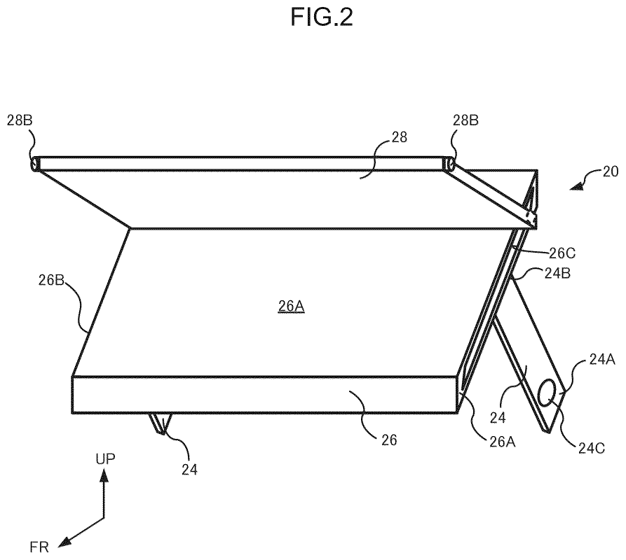

FIG. 1 is a side view schematically illustrating the configuration of a grille shutter device 20, and FIG. 2 is a perspective view from an obliquely front side schematically illustrating pertinent portions of the grille shutter device 20 of FIG. 1. As illustrated in FIG. 1, the grille shutter device 20 is installed at the rear side of a grille opening 12 of the vehicle 10. The grille opening 12 is provided at a front portion of the vehicle 10, and is open toward the front. A height in the vehicle vertical direction of the grille opening 12 is a height H. The grille opening 12 communicates the outside of the vehicle 10 with a front room 14, and is configured such that outside air can be introduced into the front room 14 from the outside of the vehicle 10.

The grille shutter device 20 includes a rotary member 24 having, at a lower part in the vehicle vertical direction of the grille opening 12 of the vehicle 10, a lower side end portion 24A that is supported by a rotary shaft 22 extending along the vehicle width direction, and being rotatable about the rotary shaft 22. As an example, the rotary shaft 22 is rotatably attached to a bumper cover 16 or the like of the vehicle 10.

As illustrated in FIG. 2, the grille shutter device 20 includes two rotary members 24, and the rotary member 24 is formed of an elongated plate member. As illustrated in FIGS. 1 and 2, at both vehicle width direction sides of a rear side face of an opening and closing member 26, which is described below, another end portion 24B at the upper side of each rotary member 24 is connected to the opening and closing member 26 such that the rear side face of the opening and closing member 26 and a length direction of the rotary member 24 are substantially orthogonal to each other. The rotary member 24 and the opening and closing member 26 may be connected by welding, or may be connected by a bolt or the like, and there is no particular limitation on the connection method, and a known connection method can be employed.

The rotary member 24 is provided with a through hole 24C at the one end portion 24A, and the rotary shaft 22 is fixed at the through hole 24C. The rotary shaft 22 is rotated clockwise and counterclockwise in the direction of the arrow M1 in FIG. 1—namely, in side view—by a drive device (not illustrated in the drawings), and the rotary member 24 fixed to the rotary shaft 22 is rotated in the same direction as the rotary shaft 22 in conjunction with rotation of the rotary shaft 22.

As illustrated in FIGS. 1 and 2, the grille shutter device 20 includes a single opening and closing member 26, and the opening and closing member 26 is, for example, formed as a substantially rectangular parallelepiped including flat faces 26A in the vehicle front-rear direction. The opening and closing member 26 is provided with opening portions 26C, which are open in an elongated shape along the length direction of respective end faces 26B, at both vehicle width direction end faces 26B. The opening portions 26C are formed in a groove shape including a bottom face (not illustrated) in the vehicle width direction, as an example. The other end portion 24B of the rotary member 24 is fixed to a substantially central portion in the vertical direction of the flat face 26A at the rear side of the opening and closing member 26.

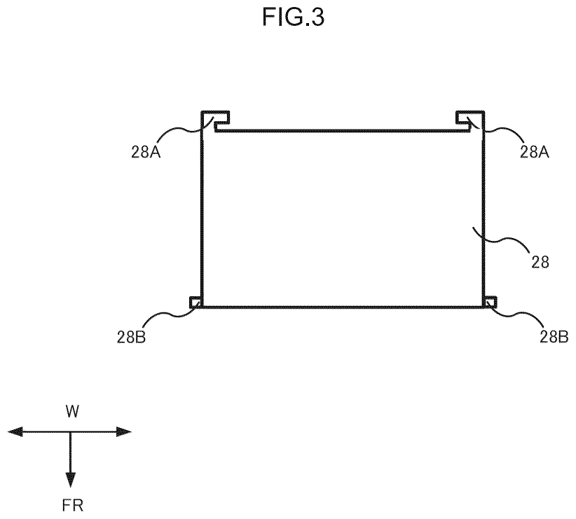

The grille shutter device 20 includes a single support member 28, and as illustrated in FIG. 2, the support member 28 is formed of a rectangular plate member. FIG. 3 is a top view schematically illustrating the support member 28. As illustrated in FIG. 3, the support member 28 includes engagement portions 28A that are engaged with the opening portions 26C of the opening and closing member 26, and that are provided at both side faces and positioned at the side of the opening and closing member 26 (rear side), which side is also referred to as another end side.

The engagement portion 28A extends outward from an end face of the support member 28 at the side of the opening and closing member, and is formed in a substantially L-shape so as to return toward the vehicle width direction inner side, and is formed with a substantially circular cross-section. The engagement portion 28A is formed with a diameter that is slightly smaller than the width in the short side direction of the opening portion 26C, and a leading end of the engagement portion 28A is attached so as to engage with the opening portion 26C from the vehicle width direction outer side. The engagement portion 28A is configured to slide inside the opening portion 26C along the length direction of the opening portion 26C.

The support member 28 is provided with columnar projections 28B at both sides positioned at an opposite side (the front side) from the opening and closing member 26, which side is also referred to as one end side. As illustrated in FIG. 1, for example, the projection 28B is rotatably supported in the direction of the arrow M2 by a bearing (not illustrated) provided at the bumper cover 16 or the like of the vehicle 10.

As illustrated in FIGS. 1 and 2, the support member 28 is configured such that when the grille opening 12 is in a closed state, the opening and closing member 26 and the support member 28 are disposed in a substantially L-shape with an apex at the vehicle rear side, as viewed from the vehicle width direction. Namely, the arrangement is such that the vehicle front side angle formed by the opening and closing member 26 and the support member 28 is smaller than 180 degrees when the grille opening 12 is in the closed state.

Explanation follows regarding opening and closing operations of the grille opening 12 in the grille shutter device 20. Opening and closing operations are controlled by a vehicle ECU (Electronic Control Unit; not illustrated) installed in the vehicle 10.

As illustrated in FIG. 1, when the rotary shaft 22 is rotated counterclockwise in the direction of the arrow M1 in FIG. 1 by a drive device (not illustrated), the rotary member 24 is rotated in conjunction with rotation of the rotary shaft 22, and the rotary member 24 is inclined in a state in which the other end portion 24B is positioned toward the vehicle front direction. When the rotary member 24 is inclined, the opening and closing member 26 is in an inclined orientation in which a lower end of the opening and closing member 26 is positioned at the vehicle front side and an upper end of the opening and closing member 26 is positioned at the vehicle rear side, respectively. At such time, the projection 28B of the support member 28 is rotated clockwise in the direction of the arrow M2 in accordance with the operation of the opening and closing member 26, and the engagement portion 28A moves along the opening portion 26C toward an opposite side (toward an obliquely rear upper side) from the direction of arrow A. Namely, the engagement portion 28A moves relatively toward the opposite side from the direction of arrow A with respect to the opening and closing member 26. Then, the grille opening 12 is put into a closed state by the opening and closing member 26 and the support member 28.

When the rotary shaft 22 is rotated clockwise in the direction of arrow M1 in FIG. 1 by a drive device (not illustrated), the rotary member 24 is rotated in conjunction with rotation of the rotary shaft 22, and as indicated by the two-dot chain line, the rotary member 24 stands upright in a state in which the other end portion 24B is positioned at the vehicle upper side. The opening and closing member 26 is in a horizontal orientation when the rotary member 24 is upright. At such time, in accordance with the operation of the opening and closing member 26, the projection 28B of the support member 28 is rotated counterclockwise in the direction of arrow M2, and the engagement portion 28A moves in the direction of arrow A (toward an obliquely front lower side) along the opening portion 26C. Namely, the engagement portion 28A moves relatively toward the side in the direction of arrow A with respect to the opening and closing member 26. Then, the grille opening 12 is put into an open state by the opening and closing member 26 and the support member 28.

Explanation follows regarding the mechanism and effects of the grille shutter device 20 in the present exemplary embodiment.

In the grille shutter device 20 of the present exemplary embodiment, since the flat face 26A at the grille opening 12 side (the front side) of the opening and closing member 26 faces the grille opening 12 when the grille opening 12 is in the closed state, the flat face 26A at the grille opening 12 side can be a design face. Further, since the grille opening 12 can be opened and closed by a single opening and closing member 26 without requiring plural opening and closing members 26, it is possible to accommodate front grilles of various shapes with improved design properties. Since the opening and closing member 26 is in a horizontal orientation when the grille opening 12 is in an open state, a larger opening area can be secured in the vehicle vertical direction. Since one end of the support member 28 at the front side is rotatably supported by the vehicle 10, and another end of the support member 28 at the rear side moves relative to the opening and closing member 26 in accordance with the opening and closing operation of the grille opening 12, the grille opening 12 can be opened and closed by a uniaxial rotation drive mechanism at the one end portion 24A of the rotary member 24. Thus, in the grille shutter device 20 of the present exemplary embodiment, design performance can be improved while also ensuring a larger opening area with a simpler structure.

Further, in the grille shutter device 20 of the present exemplary embodiment, in the closed state of the grille opening 12, since the opening and closing member 26 and the support member 28 are disposed in a substantially L-shape with an apex at the vehicle rear side, as viewed from the vehicle width direction, the grille shutter device 20 can, for example, be made to correspond to a so-called spindle-shaped front grille that is longitudinally long and that is shaped so as to be constricted toward the vehicle width direction inner side at a position above the center in the vehicle vertical direction.

Further, in the grille shutter device 20 of the present exemplary embodiment, the support member 28 is engaged with the opening portions 26C of the opening and closing member 26 from the vehicle width direction outer side at both vehicle width direction end sides, and engagement portions 28A are provided that slide along the opening portions 26C inside the opening portions 26C. Thus, the support member 28 can move relative to the opening and closing member 26 owing to the engagement portion 28A sliding inside the opening portion 26C.

In the grille shutter device 20 of the present exemplary embodiment, since the rotary shaft 22 of the rotary member 24 is provided at a vehicle vertical direction lower side of the grille opening 12, interference with peripheral components such as a wind guide mechanism can be suppressed compared to cases in which it is provided at the upper side.

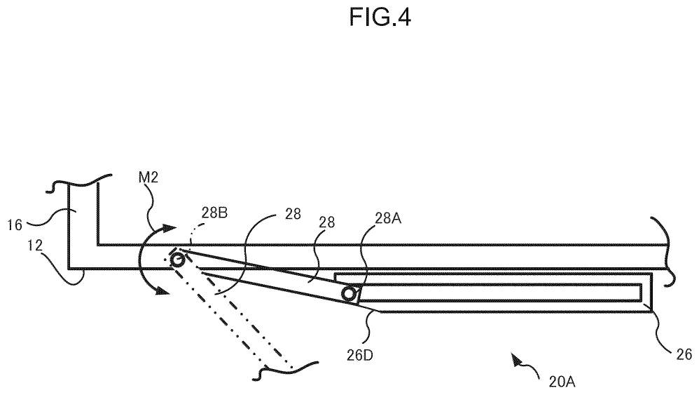

Explanation follows regarding a grille shutter device 20A that is another exemplary embodiment of the grille shutter device 20 of the above exemplary embodiment. Note that in the present exemplary embodiment, configuration that is the same as in the grille shutter device 20 of the above exemplary embodiment is denoted by the same reference numerals, and detailed explanation thereof is omitted here, and explanation is only provided regarding different portions. FIG. 4 is a side view schematically illustrating pertinent portions of a grille shutter device 20A.

As illustrated in FIG. 4, in a grille shutter device 20A of the present exemplary embodiment, when the opening and closing member 26 is in a horizontal orientation, the front lower corner portion 26D of the opening and closing member 26 is chamfered such that the support member 28 and the opening and closing member 26 are smoothly connected at the grille opening 12 side (front side).

Thus, the chamfering of the corner portion 26D enables the resistance to air guided from the grille opening 12 to be reduced, enabling air to flow rearward more efficiently.

### [Remarks]

Note that in the above exemplary embodiments, the rotary shaft 22 of the rotary member 24 is provided at the lower side of the grille opening 12; however, the present disclosure is not limited thereto, and it may be provided at the upper side of the grille opening 12. In such cases, the projection 28B of the support member 28 is configured to be supported by, for example, a bearing provided at the bumper cover 16 at a lower side of the vehicle 10. Namely, when the grille opening 12 is put in the open state by the opening and closing member 26, the opening and closing member 26 is in the horizontal orientation at the lower side of the grille opening 12.

In the above exemplary embodiments, the front face of the opening and closing member 26 is a flat face 26A; however, the present disclosure is not limited thereto. Since the face at the front side is a face that is visible from the grille opening 12 side when the grille opening 12 is in a closed state, shapes, patterns, or the like that enhance design properties may be applied.

In the above exemplary embodiments, the support member 28 includes the projection 28B; however, the present disclosure is not limited thereto. For example, a bearing may be provided instead of the projection 28B. In such cases, a shaft supported by the bearing is provided at the vehicle 10 side.

In the above exemplary embodiments, the opening and closing member 26 includes the opening portion 26C, and the support member 28 includes the engagement portion 28A; however, the present disclosure is not limited thereto. Other known sliding mechanisms may be employed, or may be appropriately modified, as long as the support member 28 is capable of relative movement with respect to the opening and closing member 26.

In the above exemplary embodiments, the opening and closing member 26 is in an inclined orientation when the rotary member 24 is inclined; however, the present disclosure is not limited thereto, and the opening and closing member 26 may be in an upright orientation. In such cases, for example, a rear side face of the opening and closing member 26 and the length direction of the rotary member 24 are obliquely connected to each other.

The configuration of the present disclosure is not limited to the above exemplary embodiments, and can be appropriately modified as long as the problems can be resolved.

What is claimed is:

1. A grille shutter device, comprising:
a rotary member having one end part that is supported by a rotary shaft along a vehicle width direction at an upper part or a lower part, in a vehicle vertical direction, of a grille opening of a vehicle, the rotary member being rotatable around the rotary shaft;
a single opening and closing member fixed to another end part of the rotary member, which assumes a horizontal orientation and puts the grille opening into an open state when the rotary member is upright, and which assumes an inclined orientation or an upright orientation and puts the grille opening into a closed state when the rotary member is inclined; and
a support member having one end part rotatably supported at the vehicle around an axis along the vehicle width direction, and another end part that moves relative to the opening and closing member in conjunction with an opening and closing operation of the grille opening.

2. The grille shutter device of claim 1, wherein, when the grille opening is in a closed state, the opening and closing member and the support member are disposed in a substantial L-shape having an apex at a vehicle rear side, as viewed from the vehicle width direction.

3. The grille shutter device of claim 1, wherein:
the opening and closing member is provided with an opening portion that is open in an elongated shape at respective end faces in the vehicle width direction, and
the support member is provided, at both end faces, with an engagement portion that engages with the opening portion from an outer side in the vehicle width direction, and that slides along the opening portion inside the opening portion.

4. The grille shutter device of claim 1, wherein the rotary shaft of the rotary member is provided at a lower side, in the vehicle vertical direction, of the grille opening.

5. The grille shutter device of claim 1, wherein the opening and closing member is chamfered such that, when the opening and closing member is in a horizontal orientation, the support member and the opening and closing member are smoothly connected at a side of the grille opening.
